(19) United States
(12) Patent Application Publication
(10) Pub. No.: US 2007/0174104 A1
(43) Pub. Date: Jul. 26, 2007

(54) METHOD AND SYSTEM FOR ROTATING ROLES IN CALENDAR EVENTS

(76) Inventors: Patrick Joseph O'Sullivan, Bellsbridge (IE); Gary Denner, Celbridge (IE)

Correspondence Address: LOTUS AND RATIONAL SOFTWARE;McGuinness & Manaras LLP, 125 NAGOG PARK, ACTON, MA, 01720, US

(21) Appl. No.: 11/428,233

(22) Filed: Jun. 30, 2006

(30) Foreign Application Priority Data
Jan. 26, 2006 (GB) GB0601548.1

(51) Int. Cl. G06F 15/02

(52) U.S. Cl. 705/9

(57) ABSTRACT

A scheduling system is provided including a server running a scheduling application and a plurality of clients running replicas of the scheduling application. A user interface is presented to a client for creating a repeating calendar event. The user interface includes a field to designate candidates for a role in the calendar event and the server includes means for rotating candidates for roles in accordance with the rules designated in the user interface. The user interface also includes means for defining attributes for a repeating calendar event, and an invitation to invitees of the calendar event includes details of the attributes.

### CROSS REFERENCE TO RELATED APPLICATIONS

The present application claims priority under 35 USC 119 to United Kingdom Application Number GB0601548.1, filed Jan. 26, 2006.

### Field of the Invention

This invention relates to the field of calendar and scheduling software. In particular, it relates to rotating roles in a repeating calendar event.

### BACKGROUND OF THE INVENTION

Messaging and collaborative software has increasing importance in the workplace. Software that allows users to schedule their work commitments and communicate such scheduling effectively and efficiently to other participants can promote work productivity by removing administrative burden from the users. IBM's Lotus Notes/Domino architecture (IBM's Lotus Notes and Domino are trade marks of International Business Machines Corporation) provides such software which connects and integrates users' resources including email, calendars and schedules, journals, to do lists, Web pages and databases.

In conventional calendar and scheduling systems a meeting moderator is established in single or repeated meetings. A meeting moderator is a presiding officer of a meeting and the term is used to encompass a number of roles within a meeting. Generally, the term is used to imply the meeting organizer. Implicit in the meeting moderator's role is ownership of the following:

1) establishing the meeting;

2) ensuring the correct people attend (by following up);

3) ensuring that the correct tools and equipment are in place (e.g. projector, phones); and

4) assigning ownership of administrative duties (e.g. chairperson, minute taker, order of speakers, managing meeting etiquette).

Specifically, in a meeting the first task that a moderator tends to do is to establish a minute taker, chairperson and agenda. Outside the meeting the moderator often has to line up the correct room equipment, dial in number, and so forth, sometimes delegating these tasks to other meeting attendees. These tasks are often manual and time consuming.

Conventional art implies the need for a permanent meeting moderator to be established, and the implicit duty of care for this moderator to manage the activities and administrative aspects of a meeting. However, it is advantageous to rotate the meeting moderator and associated meeting's tasks between the individuals that converge in repeated meetings in order to share the workload associated with the duties of the meeting moderator. The ability to delegate or reassign ownership in conventional art is a manual effort that consumes time and effort on behalf of the moderator. An implicit dialogue is required, often unnecessary, and often not desired.

In many meetings, the chairperson and minute taker are verbally rotated, usually decided at the start of a meeting. Also, at the end of each meeting the ownership of administrative duties (e.g. book next meeting, book room, book projector, contact absentees for updates, etc.) is often assigned. This is also done manually and may not be fairly distributed across the participants.

In conventional art, when the meeting moderator is absent/sick/on vacation the meeting often fails due the implicit rules that are associated with the moderator not getting fulfilled. This results in loss of opportunity and productivity, and most likely an unsuccessful meeting.

### SUMMARY OF THE INVENTION

According to a first aspect of the present invention there is provided a method for rotating roles in calendar events, comprising: creating a repeating calendar event; determining candidates for a role relating to the event; and rotating the candidates to select a candidate at each occurrence of the event.

The rotation of the selected candidate is preferably in accordance with a pre-defined rule specified by the meeting creator. The candidates may be equal to or a subset of the invitees to a calendar event and may be designated by the meeting creator.

In one embodiment, the method includes selecting candidates for a role for all instances of a repeating event when the repeating calendar event is created.

In an alternative embodiment, a scheduled process carries out the rotation and selects a candidate for a role prior to each instance of the repeating calendar event.

The method may also include determining if a selected candidate is available for the role, and, if the selected candidate is unavailable, rotating the candidates to select an alternative candidate. A candidate may be unavailable if he declines the role for an instance of a repeating calendar event. Candidates for roles may be restricted so that a candidate is only designated one role per instance of the repeating calendar event.

The method may also include defining attributes for a repeating calendar event, and sending an invitation to invitees of the calendar event including details of the attributes. The attributes may be assigned ownership to an invitee and the ownership may be rotated at each occurrence of the event. The calendar event may be updated to reflect any changes to assigned attributes.

According to a second aspect of the present invention there is provided a system for rotating roles in calendar events, comprising: a user interface for creating a repeating calendar event; means for determining candidates for a role relating to the event; and means for rotating the candidates to select a candidate at each occurrence of the event.

The system is preferably a scheduling system including: a server running a scheduling application; a plurality of clients running replicas of the scheduling application including the user interface for creating a repeating calendar event; wherein the server includes means for rotating candidates.

The means for determining the candidates may be provided as a field on the user interface. The means for rotating may rotate candidates in accordance with a pre-defined rule specified in the user interface.

In one embodiment, the means for rotating the candidates selects candidates for a role for all instances of a repeating event when the repeating calendar event is created.

In an alternative embodiment, the means for rotating includes a scheduled process which carries out the rotation and selects a candidate for a role prior to each instance of the repeating calendar event.

The user interface may provide user configurable options for designating the roles required in a repeating calendar event.

The server may determine if a selected candidate is available for the role and, if the selected candidate is unavailable, may rotate the candidates to select an alternative candidate.

The user interface may include means for defining attributes for a repeating calendar event, and an invitation to invitees of the calendar event may include details of the attributes. The attributes may be assigned ownership to an invitee and the ownership may be rotated at each occurrence of the event. The server may update the calendar event to reflect any changes to assigned attributes.

According to a third aspect of the present invention there is provided a computer program product stored on a computer readable storage medium, comprising computer readable program code means for performing the steps of: creating a repeating calendar event; determining candidates for a role relating to the event; and rotating the candidates to select a candidate at each occurrence of the event.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram of a client server system as known in the prior art;

FIG. 2 is a block diagram of a system in accordance with the present invention;

FIGS. 3A, 3B, 3C and 3D are screen shots of example embodiments of a user interface in accordance with the present invention; and

FIG. 4 is a flow diagram of the method in accordance with the present invention.

### DETAILED DESCRIPTION OF EXEMPLARY EMBODIMENTS

The method and system of rotating roles in a repeating calendar event are described in the context of a scheduling software system.

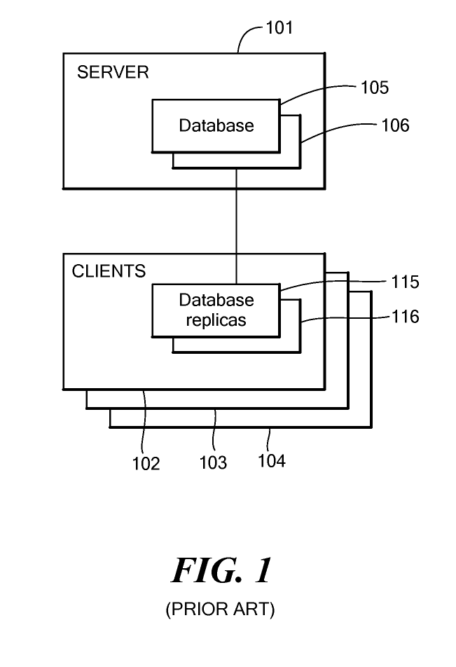

Referring to FIG. 1, a basic architecture of a scheduling system is shown with a server 101 to which a plurality of client applications 102, 103, 104 are connected. The client applications 102, 103, 104 may communicate with the server 101 via a suitable network.

The server 101 holds a number of databases 105, 106. A database 105, 106 contains a collection of documents and other information. An email inbox is a form of database and each email message in the inbox is a document. A calendar is a database and each appointment in the calendar is a document. There are other types of databases for a number of other purposes.

An authoritative copy of each database 105, 106 resides on the server 101. A client application 102 can hold replicas 115, 116 of databases. A replica 115, 116 of a database is a copy of the database 105, 106 held on the server 101.

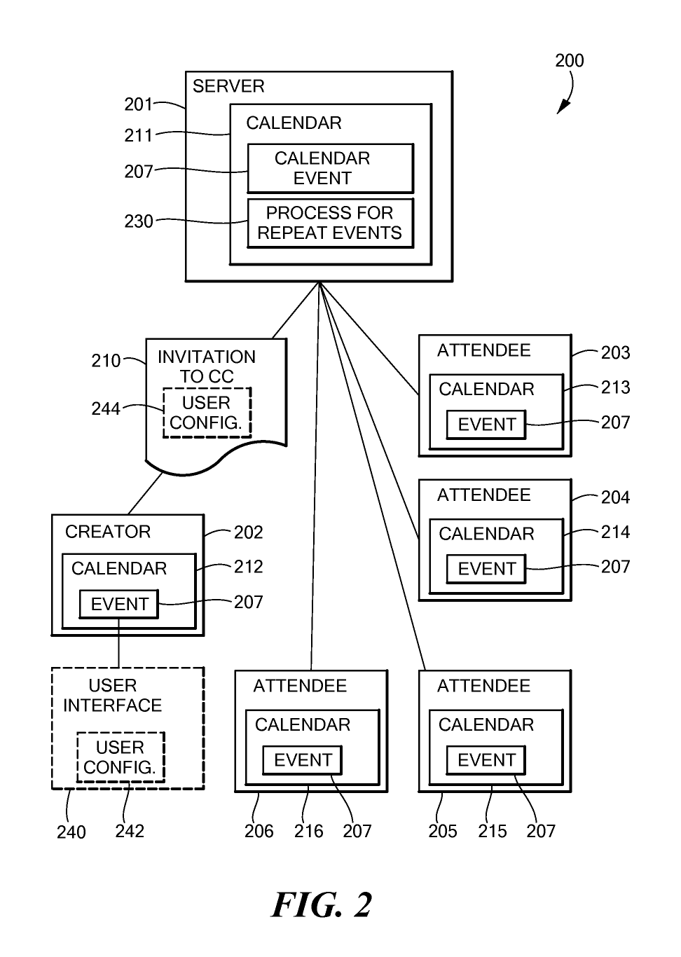

Referring to FIG. 2, a system 200 is shown with a server 201 and a number of clients 202, 203, 204, 205, 206. All the clients run a software application with messaging, calendar and scheduling functionality and are connected via the server 201.

Each client 202, 203, 204, 205, 206 has its own calendar and messaging account which are actually stored on the server 201 with the clients having local replicas on their machines. Any of the clients can be a meeting creator 202 or an attendee 203, 204, 205, 206 in accordance with the described method and system.

Each client 202, 203, 204, 205, 206 has a local replica of its unique personal calendar 212, 213, 214, 215, 216 with a master calendar 211 on the server 201. In reality, the information in these calendars actually resides on the server 201, but the calendars are “owned” by the clients. FIG. 2 is intended to be a logical view showing ownership as opposed to actual physical location.

A meeting creator 202 creates a calendar event 207. The meeting creator 202 identifies the meeting attendees 203-206 and includes these in the “to” and “cc” fields of the meeting invitation 210.

The meeting creator 202 exploits a user interface 240 that presents options for defining the attributes of the meeting. The attributes include an option for rotating key roles associated with the meeting, defining the meeting requirement details and pre-meeting tasks, and defining additional meeting information. For example, the attribute of rotating key roles may include rotating the roles of meeting modulator, chairperson, minute taker, room booker, etc. The term “rotating” is used to include all forms of choosing between a plurality of candidates according to a predefined rule. It is not limited to selecting each candidate once, for example, candidates of a higher ranking may be always chosen ahead of lower ranking candidates.

A meeting creator 202 may also have the option to customize roles. For example, a first meeting creator may wish to appoint a chairperson and a minute-taker, whereas a second meeting creator may wish to appoint additional roles for organizing audio equipment, video equipment, advertising, etc.

In addition, a candidate designated to a role in one instance of a created repeating meeting may have the option to appoint additional roles for his instance of the meeting.

In the case where there are a number of roles X which could be rotated against Y candidates, there may be provided an ability to limit the number of candidates for a role as defined by the meeting creator. For example, candidates with audio skill should not be assigned roles requiring video skills and vice versa. There may also be an inter-relation of roles such that one a candidate has been designated for a role in an instance of a repeat meeting, he is excluded from selection for another role at the same meeting instance.

In conventional scheduling systems, a calendar event is a static entity in mail files which is changed to reflect updates or rescheduling. In the described scheduling system 200, the calendar event 207 is dynamic with an automatic process 230 working in the background to accommodate the attributes defined by the meeting creator 202.

The semantics associated with conventional meeting scheduling capabilities are extended in the user interface 240 to include user configurable semantics that get embodied in a new meeting invitation 210. This provides a capability of tailoring the meeting details to the creator's perspective. In this regard the meeting creator 202 is furnished with a user interface extension 242 that allows the meeting creator 202 to:

1) enumerate these new semantics,

2) assign ownership and rotation where applicable, and

3) consolidate the logistics and criteria for a successful meeting (as perceived by the creator) into a concise and meaningful user interface that is communicated 244 to the meeting attendees when the invitation 210 is propagated.

The user interface 240 for meeting creation permits rotation of user-defined criteria as defined above, and permits the introduction of any additional meeting semantics that the meeting creator wishes to introduce.

Once the meeting gets committed then an automated process 230 is instigated on the backend server 201 to allocate the user defined rotation of candidates in designated roles.

The meeting creator 202 creates an invitation 210 to the event 207 which is sent via the server 201 to the intended attendees 203-206.

The invitation 210 and responses may be in the form of email messages in which case the address for an invitee is an email address. The invitation 210 and responses may, alternatively, be another form or combination of forms of message such as a text message or other form of communication.

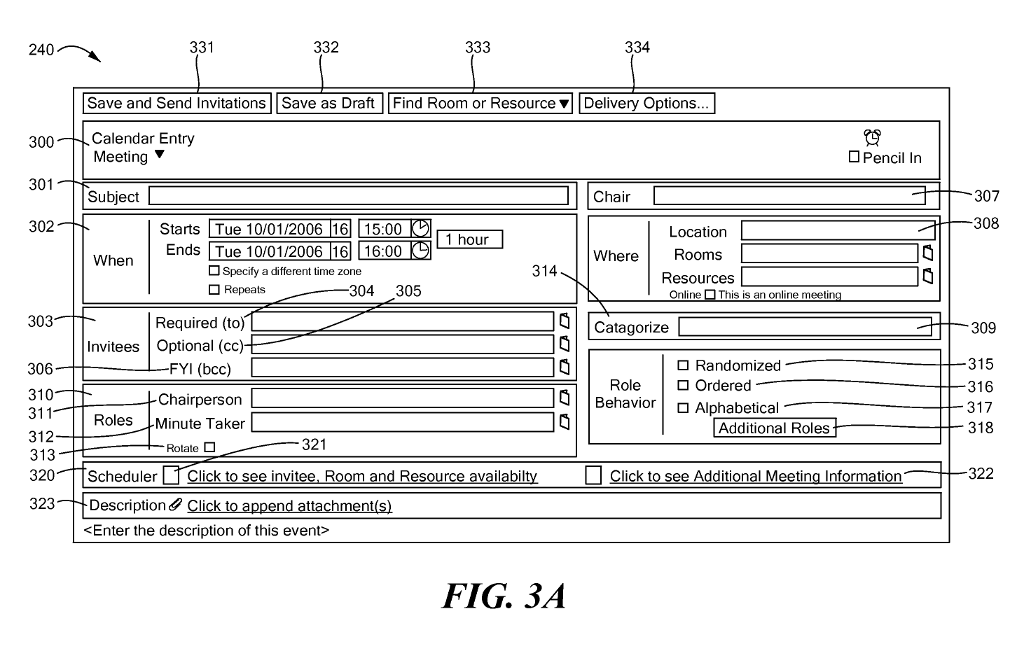

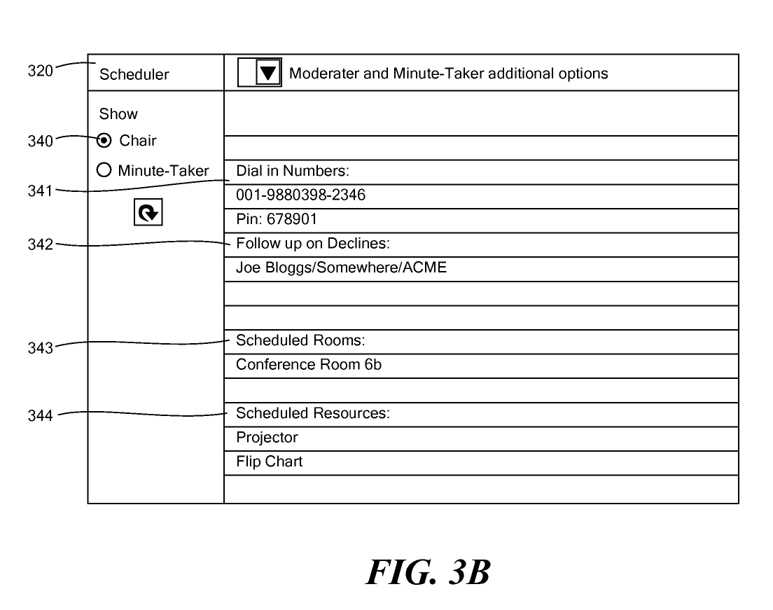

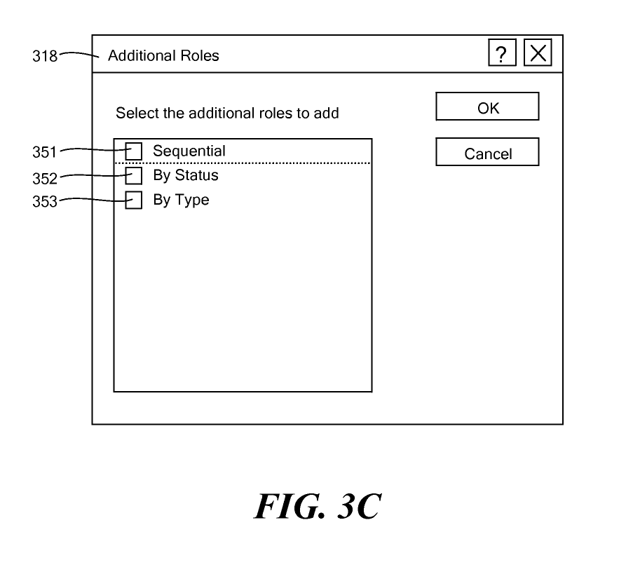

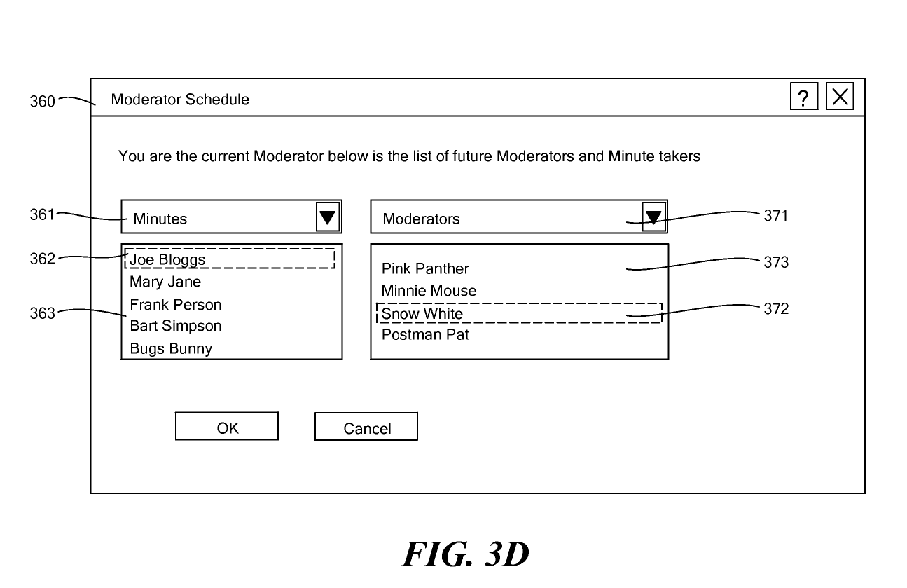

Referring to FIGS. 3A and 3B, screen shots of a user interface 240 are shown as presented to a meeting creator.

FIG. 3A shows a page 300 of a user interface 240 which is presented to a meeting creator when a new meeting is created. Fields are provided for inputting the meeting subject 301, the meeting date, time and duration 302 and whether or not the meeting is a repeat meeting 303. The option of repeat meeting 303 may allow the creator to specify the frequency of repeat and the total number of occurrences of the meeting.

A field is provided for inputting the invitees 304 with required attendees 305 (who will be specified in the “to” field of the invitation), optional attendees 306 (who will be specified in the “cc” field of the invitation), and individuals or groups who are notified of the meeting for information (who will be specified in the “bcc” field of the invitation).

A field is provided for inputting the meeting location and resources required 308. A field is provided for inputting the category 309 of meeting and a description of the event is added in this field.

A field is provided for designating one or more meeting roles 3 10. The roles field 310 includes inputs for candidates from the group of required attendees 304 who may be designated a role. The selection of candidates for the roles may be all the attendees of the meeting or a subset of the attendees. The roles may include the chairperson 311 and minute-taker 312. A field may be provided for indicating the current chairperson 307.

A button 313 may be selected to rotate the order of the candidates who are chosen to fill the roles at each instance of a repeat meeting. The roles are dynamically rotated based on the implementation of selected rules. In FIG. 3A a single button is shown to select rotation of all the specified roles; however, in an alternative embodiment, the rotation may be selected for each role individually.

A field is also provided for choosing the type of role behavior or rotation 314 applied to the moderator roles. In the alternative embodiment in which rotation is selected for each role individually, a selection of the role to be rotated is provided in this field 314. The types of rotation may be provided as a drop down menu from the rotation button 313 instead of as a separate field 314.

The types of rotation may be selected from rules such as randomized rotation 315, ordered rotation 316, or alphabetical rotation 317. These field rules of rotation are further detailed below.
The randomize option 315 in the user interface. This rule implies that a random number generated results in each individual selected in the candidate field 311, 312 getting selected proportionally and evenly.
The ordered option 316. This rule implies that the methodology for selection is based on a preferred-order-sequence that the creator proposes, and this order is respected by the associated calendar and scheduling workflow.
The alphabetical option 317. This rule implies that the methodology for selection exploits reverse and forward alphabetic ordering in selection.

The rotation may be determined by other rules such as to rotate a role candidate every second occurrence of a meeting, or such as to rotate in order of candidate seniority determined by defined hierarchical relationships. In addition, the candidates for a role can be determined by employment or qualification band. The application of the candidate selection and rotation is not limited and the examples given are some exemplary suggestions.

A further form of rotation may be provided as an option for user configurable role behavior. For example, a script may be provided by the user and plugged-in to make the decisions for the meeting creator.

Additional role behavior rules may be specified using the expansion option 318 shown in FIG. 3C. Additional rules of role behavior may include sequential 351, by status 352 or by type 353. Other forms of rules may also be configured by the meeting creator.

A scheduler interface 320 is provided which can be expanded 321 to show invitee, room and resource availability. The scheduler interface 320 can also be expanded 322 to show additional meeting information which can be specified by the meeting creator. The additional meeting information can be provided in a free format for assigning whatever meeting logistics/details that the creator wishes to include and communicate. Further details of the scheduler interface 320 are provided below with reference to FIG. 3B.

Attachments can be appended to a meeting invitation by specifying in a description field 323.

Once the meeting attributes have been specified using the page 300 of the user interface 240, options are provided at the top of the page 300 to save and send invitations 331, save the meeting as a draft 332, find a room or a resource 333, and delivery options 334 for the invitations.

FIG. 3B shows the expanded scheduler interface 320 showing additional chairperson and minute-taker options. For example, the chairperson 340 may show fields for the additional options including dial in numbers 341 for remote attendees of the meeting, attendees to follow up on 342, the scheduled room 343, and scheduled resources 344.

The scheduler interface 320 is user-customizable in such a way that a dynamic set of prerequisites can get incrementally furnished at which stage this is:

1) recorded along with the meeting event, and

2) presented to the invitees in a way that presents the data as an extension to the meeting details (under a field called “additional meeting information”).

The reason dynamism is provided in the scheduler interface 320 is that an understand of meeting events shows that different tools/capabilities/requirements are required in different meetings (e.g. some would not require a web conference). It is also proposed that this dynamic capability covers all items that are currently not managed/tracked in conventional calendar and scheduling invitations, and are not limited to the examples provided above. In essence, this gives the meeting creator carte-blanche in terms of the characteristics and details relevant to a successful meeting.

The user interface 240 accommodates fixed or rotating roles such as the minute-taker, chairperson, room booker and, additionally, any dynamic data that the meeting creator identifies as pertinent. The rotation of these events may coincide with the rotating moderator; however, there may be independent rotation of moderator/minute-taker/chairperson/dynamic-events as independent activities that can also get rotated.

FIG. 3D shows a user interface from an attendees perspective. A moderator schedule 360 is provided for meeting attendees showing the roles such as minute-taker 361 and moderator or chairperson 371. The possible candidates are shown for each role 363, 373 with a highlighted name of the current candidate in the role 362, 372.

An invitee who receives an invitation to a meeting, can accept or decline the invitation. An invitee who is designated as having a role in a scheduled meeting, may decline the role. Declining the role is independent of acceptance or declining the invitation. Therefore, an invitee may attend a meeting but declines to take a designated role, for example, for reasons of workload. The invitation may be structured such that a role must be accepted within a designated time frame and, if no acceptance is forthcoming, it will be assumed the role is declined.

The process 230 for carrying out the user specified rotation of candidates in designated roles may be provided in different forms.

In a first embodiment, the candidates are allocated for roles for the total number of occurrences of instances of a repeat meeting at the time of creation of the repeat meeting. The rotation is carried out in accordance with the user specified form of rotation through the candidates for the role.

In a second embodiment, a scheduled process is carried out prior to each instance of a repeat meeting to allocate the candidates for the roles for the next meeting instance. In this embodiment, the process remains persistent for the duration of the repeating meeting.

If a designated candidate for a role is unavailable or declines, a process automatically rotates to the next candidate in accordance with the designated form of rotation. The unavailable candidate may be rescheduled for the role at the next meeting instance. In a further modification, when an assigned candidate for a role is absent (scheduled absence or otherwise), the process may identify and acknowledge another candidate through periodic assessment of his/her calendar.

The process 230 provided on the server 201 is in isolation of the moderator and users participating in the meeting. The process 230 manages the process of rotation (randomized or otherwise) in a passive and offline way, implemented as a background server process that runs on the corporate messaging infrastructure.

The process 230 may also systematically update the calendar events in cognizance of any changes that need to get implied. These changes should extend to meeting capabilities implied in the workflow, including dynamically assigned actions configured in the user interface that are compensated based on assessment of any corrections that are required.

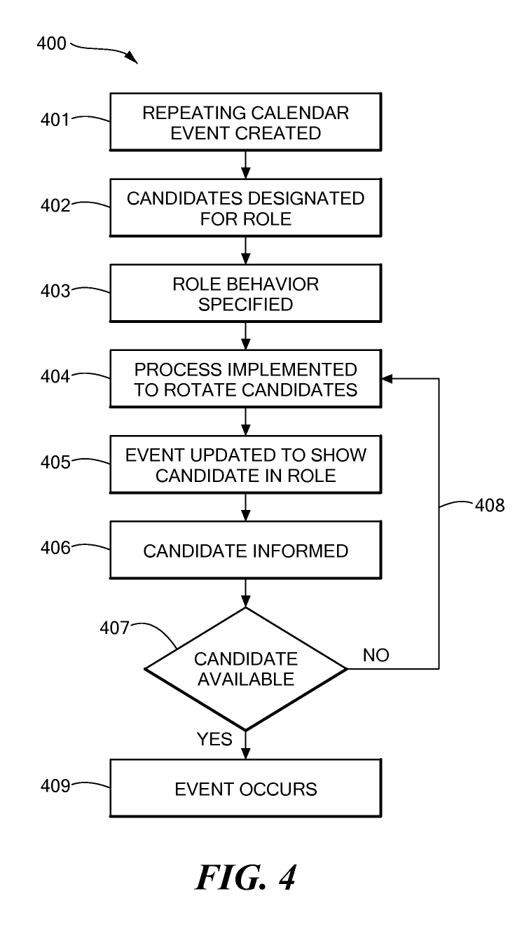

FIG. 4 shows a flow diagram 400 of an example of the described method. A repeating calendar event is created 401 by a meeting creator using the user interface. In the user interface, the candidates for a role are designated 402 and the method of rotation is specified 403.

The process is implemented in the server to rotate the candidates for the role 404 and a candidate is selected. The calendar event is updated 405 to show the candidate selected for the role and the candidate is informed 406. It is determined whether or not the candidate is available 407. This may be by the candidate accepting or by a calendar inspection by the process. If the candidate is not available, the process loops 408 and the candidates are rotated 404 to select the next candidate in the rotation. If the candidate is available, the event proceeds 409.

Conventional art assumes a template for calendar events that embody business rules in the “memo” body of the event. For example, the minute taker may be assigned here, as might be the dial in number, as might be the dress code, as might be the location directions, as might be PIN numbers/Passwords, as might be the “prerequisites” in terms of ensuring successful meeting logistics”. The described system and method embodies these often dynamic requirements in a user interface that can be tailored to the requirements of the meeting as perceived by the meeting creator. In this way, the meeting logistics are structured in a more orderly and presentable way that remains persistent for the subsequent repeats that the meeting has scheduled.

The scheduling of meetings should be considered not only from the perspective of teams within an organization, but also to meeting events that traverse the organizations boundaries (cross divisional events, industry advisory boards where members are established from representatives across a number of companies, workgroups, and so forth). There are contributions to knowledge in the area of general collaborative capabilities associated with calendar and scheduling events that extend (as useful contributions to knowledge) to other collaborative activities (e.g. shared team spaces/work areas, electronic, web conferencing and broadcasting, teleconferences, ad hoc events, and so forth).

The disclosed system can take the form of an entirely software embodiment, an entirely hardware embodiment, or an embodiment containing both software and hardware elements. The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed.

We claim:

1. A method for rotating roles in calendar events, comprising:
creating a repeating calendar event;
determining candidates for a role relating to the event; and
rotating the candidates to select a candidate at each occurrence of the event.

2. A method as claimed in claim 1, wherein the rotation of the selected candidate is in accordance with a pre-defined rule.

3. A method as claimed in claim 1, wherein the candidates are equal to or a sub-set of the invitees to a calendar event.

4. A method as claimed in claim 1, wherein the method includes selecting candidates for a role for all instances of a repeating event when the repeating calendar event is created.

5. A method as claimed in claim 1, wherein a scheduled process carries out the rotation and selects a candidate for a role prior to each instance of the repeating calendar event.

6. A method as claimed in claim 1, wherein the method includes:
determining if a selected candidate is available for the role;
if the selected candidate is unavailable, rotating the candidates to select an alternative candidate.

7. A method as claimed in claim 6, wherein a candidate is unavailable if he declines the role for an instance of a repeating calendar event.

8. A method as claimed in claim 1, including defining attributes for a repeating calendar event, and sending an invitation to invitees of the calendar event including details of the attributes.

9. A method as claimed in claim 8, wherein the attributes are assigned ownership to an invitee and the ownership is rotated at each occurrence of the event.

10. A method as claimed in claim 8, including updating the calendar event to reflect any changes to assigned attributes.

11. A system for rotating roles in calendar events, comprising:
a user interface for creating a repeating calendar event;
means for determining candidates for a role relating to the event; and
means for rotating the candidates to select a candidate at each occurrence of the event.

12. A system as claimed in claim 11, wherein the system is a scheduling system including:
a server running a scheduling application;
a plurality of clients running replicas of the scheduling application including the user interface for creating a repeating calendar event;
wherein the server includes means for rotating candidates.

13. A system as claimed in claim 11, wherein the means for determining the candidates is provided as a field on the user interface.

14. A system as claimed in claim 11, wherein the user interface provides user configurable options for designating the roles required in a repeating calendar event.

15. A system as claimed in claim 11, wherein the means for rotating rotates candidates in accordance with a pre-defined rule specified in the user interface.

16. A system as claimed in claim 11, wherein the means for rotating the candidates selects candidates for a role for all instances of a repeating event when the repeating calendar event is created.

17. A system as claimed in claim 11, wherein the means for rotating includes a scheduled process which carries out the rotation and selects a candidate for a role prior to each instance of the repeating calendar event.

18. A system as claimed in claim 11, wherein the server determines if a selected candidate is available for the role and, if the selected candidate is unavailable, rotates the candidates to select an alternative candidate.

19. A system as claimed in claim 11, wherein the user interface includes means for defining attributes for a repeating calendar event, and an invitation to invitees of the calendar event includes details of the attributes.

20. A system as claimed in claim 19, wherein the attributes are assigned ownership to an invitee and the ownership is rotated at each occurrence of the event.

21. A system as claimed in claim 19, wherein the server updates the calendar event to reflect any changes to assigned attributes.

22. A computer program product stored on a computer readable storage medium, the computer readable storage medium having stored thereon program code for rotating roles in calendar events, the program code comprising:
program code for creating a repeating calendar event;
program code for determining candidates for a role relating to the event; and
program code for rotating the candidates to select a candidate at each occurrence of the event.

23. A computer data signal embodied in a carrier wave, the computer data signal having stored thereon program code for rotating roles in calendar events, the program code comprising:
program code for creating a repeating calendar event;
program code for determining candidates for a role relating to the event; and
program code for rotating the candidates to select a candidate at each occurrence of the event.
